(19) United States
(12) Patent Application Publication
(10) Pub. No.: US 2007/0019507 A1
(43) Pub. Date: Jan. 25, 2007

(54) TIMEPIECE WITH DATE MECHANISM

(75) Inventors: Jacques Gabathuler, Collonges sous Saleve (FR); Cedric Jacot, La Chaux-de-Fonds (CH); Trung Thanh Nguyen, Grand-Lancy (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: BREITLING AG, Grenchen (CH)

(21) Appl. No.: 11/484,731

(22) Filed: Jul. 12, 2006

(30) Foreign Application Priority Data
Jul. 20, 2005 (EP) 05405446.5

(51) Int. Cl. G04B 19/24

(52) U.S. Cl. 368/28

(57) ABSTRACT

This date mechanism comprises a calendar mobile (1), a driving mobile (3) an instantaneous-jump cam (7), a finger (9b) kinematically connected to this cam (7) in order to drive the calendar mobile (1). The driving finger (9b) is borne by a release member (9) which is mounted pivotably about two axes (3a, 7a), one (3a) of which is that of the driving mobile (3), this release member (9) having an opening (9a) configured to allow an angular displacement about the second of these two axes (7a), whereby the driving finger (9b) can be released from the toothing (1a) of the calendar ring while the calendar is corrected. A return spring (8) tends to rotate the driving finger (9b) about the second pivot axis (7a) in order to bring it to butt against an edge of the opening (9b), a position in which the driving finger is engaged with the toothing of the calendar ring (1).

The present invention relates to a timepiece with date mechanism, comprising a calendar mobile engaging with an angular positioning jumper, a mobile for driving this calendar mobile, a positive connection between this driving mobile and a minute train for rotating said driving mobile at the rate of one turn every twenty-four hours, an instantaneous-jump cam, an elastic energy accumulator engaging with this cam in order to displace it instantaneously once per turn of said driving mobile, a finger kinematically connected to this cam in order to drive the calendar mobile, a kinematic connection between the driving mobile and the cam, with a degree of freedom chosen to allow the elastic energy accumulator to release its energy by imparting upon it a relative movement, to enable the driving finger to displace the calendar mobile instantaneously by one step.

It is known that in timepieces of the abovementioned type, the calendar display mobile is at risk of being driven by more than one step by the instantaneous jump drive mechanism, thus making the display jump by two, or even three dates.

Various solutions have already been proposed to prevent this risk. Amongst these solutions, one consists in locking the driving finger between two teeth after the calendar mobile has been driven by one step. This solution has a danger, however, should one wish to correct the date at this moment. This is impossible, but by forcing, serious damage could be caused to the mechanism.

In order to avoid this risk, solutions have been proposed in which a bolt is elastically engaged in the toothing of the calendar mobile and is disengaged exactly during the instantaneous driving of the calendar mobile. A mechanism of this kind is described in FR 1.609.905. The drawback of this device derives from the fact that, during the instantaneous driving of the calendar mobile, the energy accumulated for this driving must also serve to surmount the elastic force exerted upon the locking member, so that such a solution requires a daily over-consumption of energy.

There are also mechanisms comprising an instantaneous-jump driving finger which is held in the toothing of the calendar mobile after this has jumped, this driving finger being linked to the driving device by elastic means to allow the toothing of the calendar display mobile to move this finger should the date be manually reset.

The drawback of this solution derives from the fact that, in the normal state, this elastic finger is free and is not therefore under tension, so that it is difficult to have a precise rest position due to remanence phenomena. Moreover, the equilibrium between the spring of the instantaneous-jump drive and that of the finger is difficult to achieve, since the finger must be, on the one hand, sufficiently rigid to drive and then lock the disk and, on the other hand, sufficiently flexible to allow the correction.

In CH 525 508, there has further been proposed a driving device for an instantaneous-jump calendar display, which is solely constituted by members borne by the hour wheel and the minute wheel pinion and in which the member borne by the wheel and the minute wheel pinion is firstly displaced about an eccentric pivot relative to the minute wheel, moving it away from its rest position while loading a spring coaxial with the minute wheel. At the end of the loading, this member is released, which allows it to be projected into the toothing of the calendar display disk so as to drive it instantaneously by one step. At the end of this drive, the finger of the driving member is situated outside the toothing of the calendar disk, so that this mechanism contains no means for preventing this disk from jumping by more than one step.

The object of the present invention is to eliminate, at least partially, the abovementioned drawbacks.

To this end, the subject of this invention is a timepiece with calendar mechanism of the abovementioned type, such as defined in claim 1.

The main advantages of the solution forming the subject of the invention are the fact that the position of the finger in the normal state is perfectly defined and that the spring which holds the finger in this normal position is preloaded. Another advantage derives from the fact that the driving device of the instantaneous-jump calendar mobile does not have to surmount the force holding the driving finger in its normal position. The driving finger hence behaves like a rigid finger, except when the calendar mobile is displaced when this finger is engaged in its toothing. Finally, the number of parts involved is reduced to a minimum and this device requires no adjustment during the assembly.

The appended drawings illustrate, diagrammatically and by way of example, an embodiment of the timepiece forming the subject of the present invention.

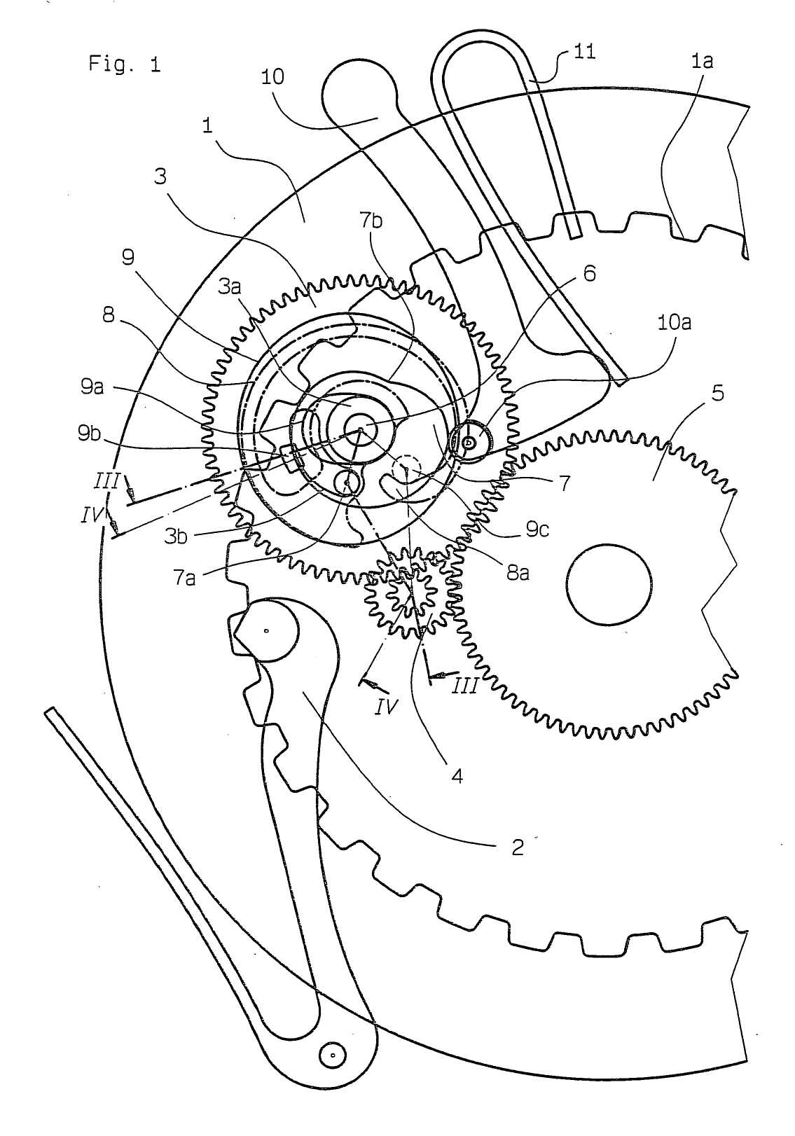

FIG. 1 is a plan view of the date mechanism of this timepiece, showing this mechanism just before the instantaneous jump;

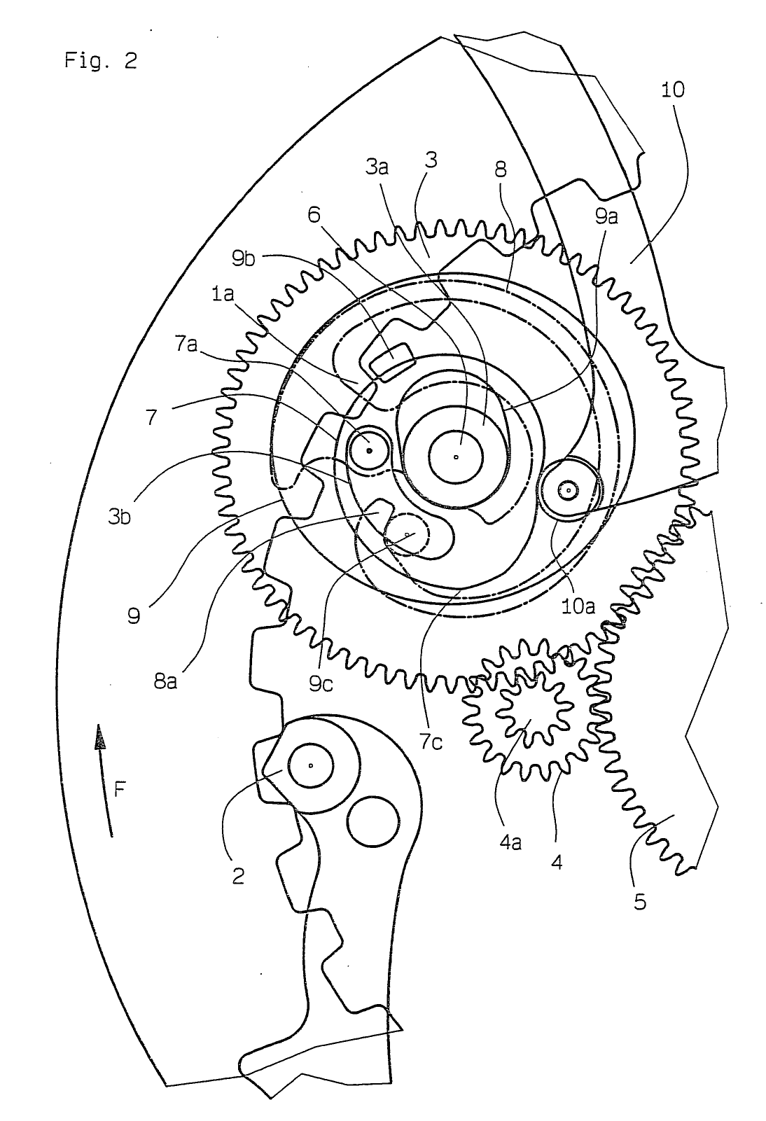

FIG. 2 is an enlarged partial view of FIG. 1, showing the date mechanism just after the instantaneous jump;

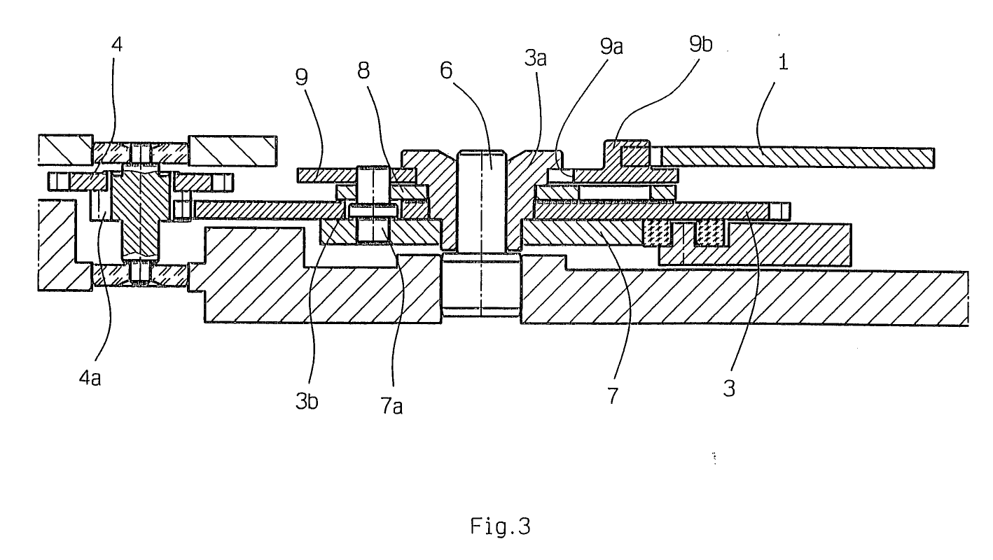

FIG. 3 is a sectional view along the line III-III of FIG. 1;

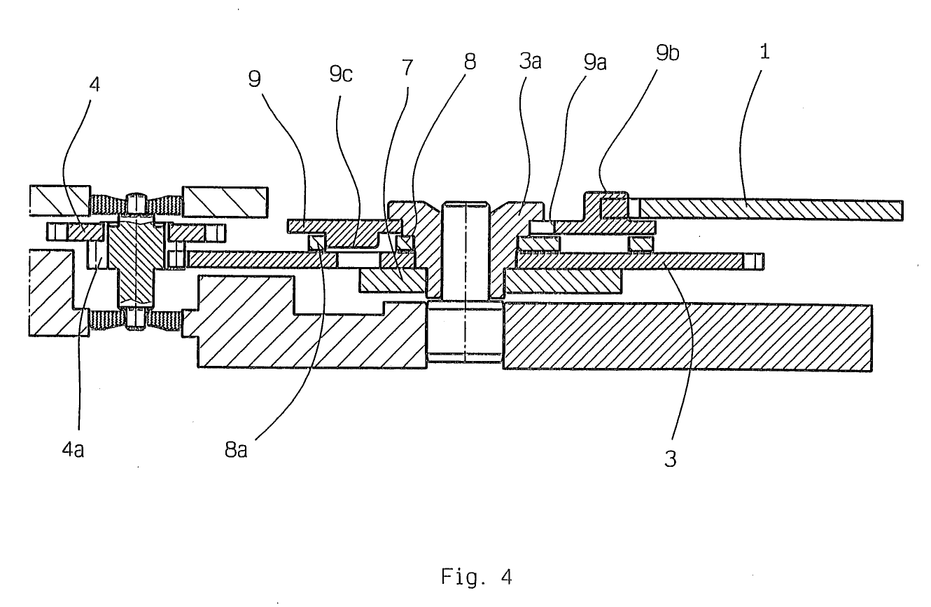

FIG. 4 is a sectional view along the line IV-IV of FIG. 1;

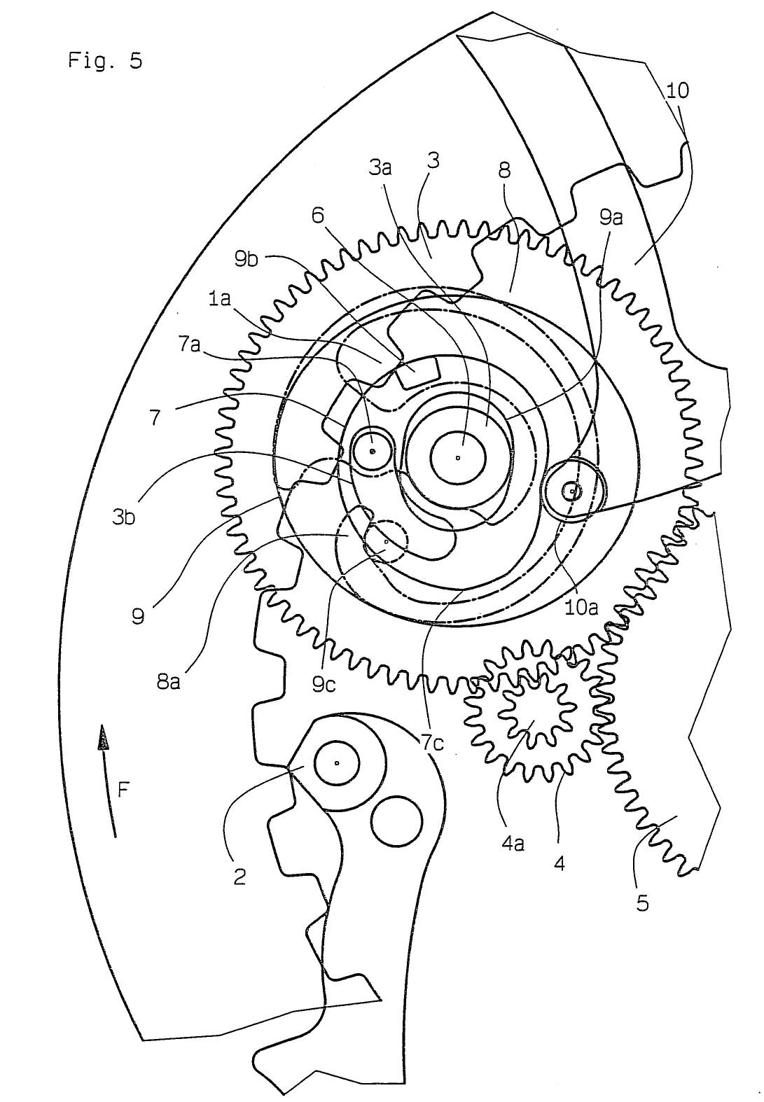

FIG. 5 is a view similar to FIG. 2 in another position of the mechanism.

The mechanism illustrated by FIG. 1 comprises a calendar mobile 1 in the form of a ring or a disk bearing the numerals 0 to 31 (not represented) and with an inner toothing 1a of thirty-one teeth, engaging with a spring-action positioning jumper 2.

A driving wheel 3 (FIG. 2) of the calendar mobile 1 meshes with a pinion 4a of a reducer mobile 4 meshing with the hour wheel 5 or cannon wheel. This hour wheel 5 makes one turn in twelve hours and the gear ratio between this hour wheel 5 and the driving wheel 3 is 2/1, so that the driving wheel 3 makes one turn in twenty-four hours.

The driving wheel 3 is fixedly connected to a hub 3a mounted pivotably on an axis 6. This hub 3a bears an instantaneous-jump cam 7, in which an eccentric pin 7a is press-fitted (FIGS. 2 and 3). This eccentric pin 7a passes through an opening 3b in the shape of an annular sector, centered on the axis of the driving wheel 3. This eccentric pin 7a further passes through one end of a return spring 8, through which the hub 3a of the driving wheel 3 also passes, so that this end of the return spring 8 is held fixedly between these two securing elements 3a and 7a. Finally, the eccentric pin 7a passes through a plate-shaped release member 9, additionally provided with an elongated opening 9a delimited at its ends by two arcs of circles of identical radius mutually linked by two arcs of concentric circles whose radii differ from the value of the diameters of the two circular arcs delimiting the ends of the opening 9a. The foot of the perpendicular dropped from the axis of the eccentric pin 7a onto the straight line joining the centers of the two circular arcs delimiting the ends of the elongated opening 9a is situated midway between the centers of these two circular arcs (FIG. 2).

By virtue of this arrangement, the release member 9 is able to rotate about the axis of the eccentric pin 7a through an amplitude corresponding to the distance separating the centers of the two circular arcs delimiting the ends of the elongated opening 9a.

This release member 9 bears on one face a driving finger 9b intended to enter into engagement with the toothing 1a of the calendar ring 1. On the other face, this release member 9 bears a circular projection 9c, onto which a curved end 8a of the return spring 8 is hooked, subjecting this return spring 8 to a fixed preload. By virtue of this arrangement, the driving finger 9b behaves like a rigid finger while the calendar mobile 1 is driven, given that the elongated opening 9a of the release member 9 is held abutted against the hub 3a of the driving mobile 3. By contrast, when this finger 9b is in the position illustrated by FIG. 2 and the calendar mobile 1 is driven in the direction of the arrow F by the manual date-resetting mechanism (not represented), the release member 9 is able to pivot about the eccentric pin 7a, counter to the force of the spring 8, into the position illustrated in FIG. 5, allowing the driving finger 9b to move to make room for the tooth of the toothing 1a of the calendar mobile 1.

The date mechanism further comprises an energy accumulator for the instantaneous jump of the calendar mobile. This energy accumulator (FIG. 1) comprises a lever 10 provided with a roller 10a pressed against the edge of the cam 7 by an instantaneous-jump spring 11. FIG. 1 illustrates this instantaneous-jump date mechanism just before the instantaneous jump, at the moment when the maximum energy is accumulated in the instantaneous-jump spring 11 through tilting of the lever 10 in the anti-clockwise direction. This position corresponds to midnight. As soon as the cam 7 is driven by the edge of the annular-sector-shape opening 3b in the driving wheel 3 from the position illustrated by FIG. 1, the roller 10a passes the tip of the cam 7, whereby the energy of the instantaneous-jump spring 11 can be released, abruptly rotating the cam 7, the release member 9 with its driving finger 9b and the return spring 8 into the position illustrated by FIG. 2, in which the unloading of the instantaneous-jump spring 11 is arrested by a slightly concave portion 7b of the cam 7, allowing the calendar mobile 1 to be advanced by one step in cooperation with the spring-action positioning jumper 2. The detention of the cam 7 in the position illustrated by FIG. 2 by its concave portion 7b corresponds to the holding of the driving finger 9b between two teeth 1a of the calendar mobile 1, preventing the latter from moving by more than one step, consecutively to the impetus imparted upon it by the release of the instantaneous-jump spring 11, in which the energy necessary for the instantaneous jump has been stored between the concave part 7b of the cam 7 and its tip 7c, corresponding to its part of greatest radius.

The displacement of this unit formed by the cam 7, the release member 9 and the return spring 8, mutually linked by the pin 7a, is possible by virtue of the annular-sector-shaped opening 3b made through the driving mobile 3.

As has been discovered in the course of the preceding description, when the calendar mobile 1 is being driven, the driving finger 9b behaves like a rigid finger owing to the fact that the elongated opening 9a in the release member 9 is held by the return spring 8 against a stop formed by the hub 3a of the driving mobile 3, the pivot axis of which is coaxial with that of the driving finger 9b. The trajectory of this driving finger 9b is therefore perfectly defined, in which case the driving finger behaves, therefore, like a fixed finger.

By contrast, when a tooth 1a of the calendar mobile exerts an oppositely directed torque upon the driving finger 9b, the latter pivots about the second eccentric pivot axis 7a, counter to the force of the return spring 8. The driving finger 9b then behaves like an elastic finger. The two modes of behavior of the driving finger 9b therefore have no influence one upon the other.

Since the spring 8 is preloaded, it is possible to precisely define the torque necessary to hold the opening 9a of the release member 9 abutted against the hub 3a with a view to allowing the detention of the calendar mobile 1 after the instantaneous jump, yet allowing the release of the driving finger 9b through pivoting of the release member 9 about the eccentric pin 7a, when the calendar mobile is manually actuated by the date-resetting device.

1. A timepiece with date mechanism, comprising a calendar mobile (1) engaging with an angular positioning jumper (2), a mobile (3) for driving this calendar mobile (1), a positive connection (4, 5) between this driving mobile (3) and a minute train for rotating said driving mobile (3) at the rate of one turn every twenty-four hours, an instantaneous-jump cam (7), an elastic energy accumulator (10, 11) engaging with this cam (7) in order to displace it instantaneously once per turn of said driving mobile (3), a finger (9b) kinematically connected to this cam (7) in order to drive the calendar mobile (1), a kinematic connection (3b, 7a) between the driving mobile (3) and the cam (7), with a degree of freedom chosen to allow said elastic energy accumulator (10, 11) to release its energy by imparting upon it a relative movement, to enable the driving finger (9b) to displace the calendar mobile (1) instantaneously by one step, wherein the driving finger (9b) is borne by a release member (9) which is mounted pivotably about two axes, the first of which is that of the hub (3a) of said driving mobile (3) and the second of which is that of a pin (7a) fixedly connected to this driving mobile (3), this release member (9) having an opening (9a) configured to allow an angular displacement about the second of these two axes, whereby the driving finger (9b) can be released from the toothing (1a) of the calendar while the calendar is corrected, and wherein a preloaded return spring (8) tends constantly to rotate said driving finger (9b) about said second pivot axis in order to bring an edge of said opening (9a) to butt against said hub (3a), a position in which said driving finger is engaged with the toothing of said calendar ring (1).

2. The timepiece as claimed in claim 1, in which the respective ends of said preloaded spring (8) are fixedly connected to an anchoring element (9c) of said member (9) bearing the driving finger (9b) and with the two pivot axes (3a, 7a) of this same member, said spring being held under pretension between its two ends.
